(19) United States
(12) Patent Application Publication
(10) Pub. No.: US 2013/0115524 A1
(43) Pub. Date: May 9, 2013

(54) RECHARGEABLE ELECTROCHEMICAL CELLS

(71) Applicants: Arnd GARSUCH, Ludwigshafen (DE); Hubert GASTEIGER, Muenchen (DE); Michele PIANA, Dietersheim (DE); Nikolaos TSIOUVARAS, Muenchen (DE)

(72) Inventors: Arnd GARSUCH, Ludwigshafen (DE); Hubert GASTEIGER, Muenchen (DE); Michele PIANA, Dietersheim (DE); Nikolaos TSIOUVARAS, Muenchen (DE)

(21) Appl. No.: 13/668,889

(22) Filed: Nov. 5, 2012

Related U.S. Application Data
(60) Provisional application No. 61/556,302, filed on Nov. 7, 2011.

(51) Int. Cl. H01M 4/86

(52) U.S. Cl. CPC H01M 4/86
USPC 429/402

(57) ABSTRACT

The present invention relates to rechargeable electrochemical cells comprising (A) at least one cathode comprising (A1) at least one cathode active material comprising (a) at least one graphitized carbon black and (aa) at least one binder, and optionally at least one solid material through which gas can diffuse or which optionally serves as a carrier for the cathode active material, and B) at least one anode comprising metallic magnesium, metallic aluminum, metallic zinc, metallic sodium or metallic lithium.

The present invention further relates to the use of inventive electrochemical cells and to metal-air batteries comprising the latter.

The present invention relates to rechargeable electrochemical cells comprising (A) at least one cathode comprising (A1) at least one cathode active material comprising (a) at least one graphitized carbon black and (aa) at least one binder, and optionally at least one solid material through which gas can diffuse or which optionally serves as a carrier for the cathode active material, and B) at least one anode comprising metallic magnesium, metallic aluminum, metallic zinc, metallic sodium or metallic lithium.

The present invention further relates to the use of inventive electrochemical cells and to metal-air batteries comprising the latter.

Secondary batteries, accumulators or “rechargeable batteries” are just some embodiments by which electrical energy can be stored after generation and used when required. Owing to the significantly better power density, there has in recent times been a move away from the water-based secondary batteries toward development of those batteries in which the charge transport in the electrical cell is accomplished by lithium ions.

However, the energy density of conventional lithium ion accumulators which have a carbon anode and a cathode based on metal oxides is limited. New horizons with regard to the energy density were opened up by lithium-sulfur cells and especially by lithium-oxygen or lithium-air cells. In a customary embodiment, a metal, especially lithium, is oxidized with atmospheric oxygen in a nonaqueous electrolyte to form an oxide or peroxide, i.e. in the case of lithium to form Li₂O or Li₂O₂. The energy released is utilized electrochemically. Such batteries can be recharged by reducing the metal ions formed in the course of discharge. It is known that gas diffusion electrodes (GDEs) can be used as the cathode for this purpose. Gas diffusion electrodes are porous and have bifunctional action. Metal-air batteries must enable the reduction of the atmospheric oxygen to oxide or peroxide ions in the course of discharging, and the oxidation of the oxide or peroxide ions to oxygen in the course of charging. For example, it is known that gas diffusion electrodes can be constructed on a carrier material composed of fine carbon which has one or more catalysts for catalysis of the oxygen reduction or oxygen evolution.

For example, A. Débart et al., Angew. Chem. 2008, 120, 4597 (Angew. Chem. Int. Ed. Engl. 2008, 47, 4521) discloses that catalysts are required for such gas diffusion electrodes. Débart et al. mention Co₃O₄, Fe₂O₃, CuO and CoFe₂O₄, and they give reports of α-MnO₂ nanowires and compare them with MnO₂, β-MnO₂, γ-MnO₂, λ-MnO₂, Mn₂O₃ and Mn₃O₄.

J. Electrochem. Soc., 157, A1016 (2010) describes lithium-air batteries which comprise those air electrodes which comprise either only carbon black or noble metals on carbon black as the cathode active material.

However, the materials known from the prior art cited above are still in need of improvement with regard to at least one of the following properties: electrocatalytic activity, resistance to chemicals, electrochemical corrosion resistance, mechanical stability, good adhesion on the carrier material and low interaction with binder, conductive black and/or electrolyte. In addition, optimization of the costs caused by material and production expenditure should be taken into account, in order to promote the proliferation of this new energy storage technology.

It was thus an object of the present invention to provide rechargeable electrochemical cells which constitute an advance with regard to at least one of the aforementioned properties. A particularly important feature of the rechargeable electrochemical cells is ultimately the cycling stability, which has to be improved with otherwise comparable properties of the cells.

This object is achieved by a rechargeable electrochemical cell defined at the outset, which comprises
A) at least one cathode comprising
   (A1) at least one cathode active material comprising
   (a) at least one graphitized carbon black and
   (aa) at least one binder, and
   optionally at least one solid medium through which gas can diffuse or which optionally serves as a carrier for the cathode active material,
and
B) at least one anode comprising metallic magnesium, metallic aluminum, metallic zinc, metallic sodium or metallic lithium.

The cathode of the rechargeable electrochemical cell, also called cathode (A) for short in the context of the present invention, comprises at least one cathode active material, also called cathode active material (A1) for short hereinafter, which comprises at least one graphitized carbon black, also called graphitized carbon black (a) for short hereinafter, and at least one binder, also called binder (aa) for short in the context of the present invention, and optionally at least one solid medium through which gas can diffuse and which optionally serves as a carrier for the cathode active material.

In a preferred embodiment of the inventive rechargeable electrochemical cell, the cathode (A) is a gas diffusion electrode.

Graphitized carbon blacks and the production thereof are known in principle to those skilled in the art. Commercially available examples are the graphitized carbon blacks PureBLACK™ from Superior Graphite or TOKABLACKT™ from TOKAI CARBON CO., LTD.

M. Wissler describes, in J. Power Sources, 156 (2006), 143-144, the appearance and formation of graphitized carbon black. One feature of graphitized carbon blacks is typically a lower BET surface area than the corresponding nongraphitized carbon blacks.

In a preferred embodiment of the inventive rechargeable electrochemical cell, the graphitized carbon black (a) has a BET surface area in the range from 1 to 150 m²/g, preferably in the range from 10 to 120 m²/g and especially in the range from 50 to 100 m²/g. The BET surface area is determined to ISO 9277.

Graphitized carbon blacks can be produced, for example, by thermal treatment of carbon blacks, the carbon blacks used having been produced by one of the known carbon black production processes, for example the furnace process, gas black process, lamp black process, acetylene black process and thermal black process. The thermal treatment takes place preferably at a temperature of more than 2000° C., especially more than 2500° C. In this operation, the proportion and the extent of regions having a graphite structure increases. This can easily be seen by means of a scanning electron microscope (SEM) or by means of high resolution transmission electron microscopy (HRTEM) on nongraphitized and graphitized carbon blacks. In addition, in the case of graphitized carbon black, a strong signal occurs at a 2 theta value of about 26° in the x-ray powder diffractogram.

In a further preferred embodiment of the inventive rechargeable electrochemical cell, the graphitized carbon black (a) has been obtained by thermal treatment of a carbon black which has been produced by a process selected from the furnace process, gas black process, lamp black process, acetylene black process and thermal black process, at a temperature of more than 2000° C.

Graphitized carbon blacks are typically in the form of particles which preferably have an average particle size of 0.1 to 10 μm, especially of 0.5 to 1 μm. The average particle size is determined by means of microscopic particle size evaluation. Under an electron microscope, it can be seen that the carbon black particles are in turn composed of a multitude of smaller particles, called primary particles, the primary particles preferably having an average particle size of 10 to 200 nm, especially of 40 to 120 nm.

In a further preferred embodiment of the inventive rechargeable electrochemical cell, the graphitized carbon black (a) is in the form of particles having an average particle size in the range from 0.1 to 10 μm, especially of 0.5 to 1 μm.

The cathode active material (A1) comprises, as well as the at least one graphitized carbon black (a), at least one binder (aa). The binder (aa) is typically an organic polymer. Binder (aa) serves principally for mechanical stabilization of the cathode active material (A1), by virtue of carbon black particles being bonded to one another by the binder, and also has the effect that the cathode active material has sufficient adhesion to an output conductor. The binder (aa) is preferably chemically inert toward the chemicals with which it comes into contact in the electrochemical cell.

In one embodiment of the present invention, binder (aa) is selected from organic (co)polymers. Examples of suitable organic (co)polymers may be halogenated or halogen-free. Examples are polyethylene oxide (PEO), cellulose, carboxymethylcellulose, polyvinyl alcohol, polyethylene, polypropylene, polytetrafluoroethylene, polyacrylonitrile-methyl methacrylate copolymers, styrene-butadiene copolymers, tetrafluoroethylene-hexafluoropropylene copolymers, vinylidene fluoride-hexafluoropropylene copolymers (PVdF-HFP), vinylidene fluoride-tetrafluoroethylene copolymers, perfluoroalkyl vinyl ether copolymers, ethylene-tetrafluoroethylene copolymers, vinylidene fluoride-chlorotrifluoroethylene copolymers, ethylene-chlorofluoroethylene copolymers, ethylene-acrylic acid copolymers, optionally at least partially neutralized with alkali metal salt or ammonia, ethylene-methacrylic acid copolymers, optionally at least partially neutralized with alkali metal salt or ammonia, ethylene-(meth)acrylic ester copolymers, polyimides and polyisobutene.

Suitable binders are especially polyvinyl alcohol and halogenated (co)polymers, for example polyvinyl chloride or polyvinylidene chloride, especially fluorinated (co)polymers such as polyvinyl fluoride and especially polyvinylidene fluoride and polytetrafluoroethylene. Of particular suitability are tetrafluoroethylene polymer, or sulfonated tetrafluoroethylene polymer exchanged with lithium ions, which is also referred to as Li-exchanged Nafion®.

The mean molecular weight M_{W} of binder (aa) may be selected within wide limits, suitable examples being 20 000 g/mol to 1 000 000 g/mol.

In one embodiment of the present invention, the cathode active material (A1) comprises in the range from 10 to 60% by weight of binder (aa), preferably 20 to 45% by weight and more preferably 30 to 35% by weight, based on the total mass of components (a) and (aa).

Binder (aa) can be incorporated into cathode active material (A1) by various processes. For example, it is possible to dissolve a soluble binder (aa) such as polyvinyl alcohol in a suitable solvent or solvent mixture, for example in water/isopropanol, and to prepare a suspension with the further constituents of the cathode active material (A1). After application to a suitable substrate, the solvent or solvent mixture is removed, for example evaporated, to obtain a cathode comprising the cathode active material (A1). A suitable solvent for polyvinylidene fluoride is NMP. The application can be accomplished, for example, by spraying, for example spray application or atomization, and also knifecoating, printing or by pressing. In the context of the present invention, atomization also includes application with the aid of a spray gun, a process frequently also referred to as “airbrush method” or “airbrushing” for short.

If it is desirable to use sparingly soluble polymers as binder (aa), for example polytetrafluoro-ethylene, tetrafluoroethylene-hexafluoropropylene copolymers or Li-exchanged Nafion®, a suspension of particles of the relevant binder (aa) and graphitized carbon black (a), and also further possible constituents of the cathode active material (A1), is prepared and processed as described above to give a cathode.

The cathode active material (A1) may, as well as components (a) and (aa), in principle also comprise further components. For example, the cathode active material (A1) may comprise particular amounts of transition metals or transition metal compounds in molecular form or in the form of particles having an average particle size in the range from 1 nm to 100 μm, the transition metals or transition metal compounds especially being those which catalyze the reduction of oxygen O₂ and/or the oxidation of oxide and/or peroxide anions. Without any claim to completeness, representatives of such transition metals or transition metal compounds are, for example, platinum, gold, Pt—Au mixtures, Co₃O₄, Fe₂O₃, CuO, CoFe₂O₄, MnO₂, β-MnO₂, γ-MnO₂, λ-MnO₂, Mn₂O₃ and Mn₃O₄. However, it has been found that a cathode active material which comprises components (a) and (aa) as main constituents and to which no transition metals or transition metal compounds are added as a catalyst catalyzes the reduction of oxygen O₂ and the oxidation of oxide and peroxide anions.

In one embodiment of the present invention, the cathode active material (A1) consists very substantially of components (a) and (aa), which means that the total mass of components (a) and (aa) in the cathode active material (A1), based on the total mass of the cathode active material (A1), is more than 90%, preferably more than 95%, more preferably more than 99% to not more than 100%.

In a further preferred embodiment of the inventive rechargeable electrochemical cell, the cathode active material (A1) comprises between 0 and 0.05% by weight, preferably between 0 and 0.001% by weight, based on the total mass of the cathode active material, of a transition metal or transition metal compound in molecular form or in the form of particles having an average particle size in the range from 1 nm to 100 μm.

The cathode (A) comprises, as well as the cathode active material (A1), optionally at least one solid medium, also called medium (A2) for short in the context of the present invention, through which gas can diffuse or which optionally serves as a carrier for the cathode active material (A1).

In one embodiment of the present invention, the cathode active material (A1), due to its composition and its structure, is already self-supporting and gas-pervious, and so it is unnecessary to use a medium (A2).

Solid media (A2) in the context of the present invention are preferably those porous bodies through which oxygen or air can diffuse even without application of elevated pressure, for example metal meshes and gas diffusion media composed of carbon, especially activated carbon, and also carbon on metal mesh.

In one embodiment of the present invention, air or atmospheric oxygen can flow essentially unhindered through medium (A2).

In one embodiment of the present invention, medium (A2) is a medium which conducts electrical current.

In a preferred embodiment of the present invention, medium (A2) is chemically inert toward the reactions which proceed in an electrochemical cell in standard operation, i.e. in the course of charging and in the course of discharging.

In one embodiment of the present invention, medium (A2) has an internal BET surface area in the range from 20 to 1500 m²/g, which is preferably determined as the apparent BET surface area.

In one embodiment of the present invention, medium (A2) is selected from metal meshes, for example nickel meshes or tantalum meshes. Metal meshes may be coarse or fine.

In another embodiment of the present invention, medium (A2) is selected from electrically conductive fabrics, for example mats, felts or nonwovens composed of carbon, which comprise metal filaments, for example tantalum filaments or nickel filaments.

In one embodiment of the present invention, medium (A2) is selected from gas diffusion media, for example activated carbon, aluminum-doped zinc oxide, antimony-doped tin oxide or porous carbides or nitrides, for example WC, Mo₂C, Mo₂N, TiN, ZrN or TaC.

In addition, it is possible to apply the cathode active material (A1) in the form of a liquid formulation comprising graphitized carbon black (a) and binder (aa) and a suitable solvent or solvent mixture, as described above, to a medium (A2), which is an electrically insulating flat material which can typically be used as a separator in electrochemical cells and is described in detail below.

In addition, the cathode (A) may have further constituents customary per se, for example an output conductor, which may be configured in the form of a metal wire, metal grid, metal mesh, expanded metal, metal sheet or metal foil, stainless steel being particularly suitable as the metal.

Further components of cathode (A) may, for example, also be solvents, which are understood to mean organic solvents, especially isopropanol, N-methylpyrrolidone, N,N-dimethylacetamide, amyl alcohol, n-propanol or cyclohexanone. Further suitable solvents are organic carbonates, cyclic or noncyclic, for example diethyl carbonate, ethylene carbonate, propylene carbonate, dimethyl carbonate and ethyl methyl carbonate, and also organic esters, cyclic or noncyclic, for example methyl formate, ethyl acetate or γ-butyrolactone (gamma-butyrolactone), and also ethers, cyclic or noncyclic, for example 1,3-dioxolane.

In addition, the cathode (A) may comprise water.

In one embodiment of the present invention, cathode (A) has a thickness in the range from 5 to 100 μm, preferably from 10 to 20 μm, based on the thickness without output conductor.

Cathode (A) may be configured in various forms, for example in rod form, in the form of round, elliptical or square columns, or in cuboidal form, especially also as a flat electrode. For instance, it is possible, in the case that medium (A2) is selected from metal meshes, that the shape of the cathode (A) is essentially defined by the shape of the metal grid.

In the inventive rechargeable electrochemical cell, in the course of the discharging operation thereof, a gas is reduced at the cathode (A), especially molecular oxygen O₂. Molecular oxygen O₂ can be used in dilute form, for example in air, or in highly concentrated form.

In a further embodiment of the inventive rechargeable electrochemical cell, molecular oxygen O₂ is reduced at the cathode (A) in the course of the discharging operation of the electrochemical cell.

Inventive rechargeable electrochemical cells further comprise at least one anode, also called anode (B) for short hereinafter, which comprises metallic magnesium, metallic aluminum, metallic zinc, metallic sodium or metallic lithium. Anode (B) preferably comprises metallic lithium. Lithium may be present in the form of pure lithium or in the form of a lithium alloy, for example lithium-tin alloy or lithium-silicon alloy or lithium-tin-silicon alloy.

In a further embodiment of the present invention, the inventive rechargeable electrochemical cell is a lithium-oxygen cell, for example a lithium-air cell.

In one embodiment of the present invention, inventive rechargeable electrochemical cells comprise one or more separators by which cathode and anode are mechanically separated from one another. Suitable separators are polymer films, especially porous polymer films, which are unreactive toward metallic lithium, the reaction products formed at the cathode in the discharging operation, and toward the electrolyte in the inventive rechargeable electrochemical cells. Particularly suitable materials for separators are polyolefins, especially porous polyethylene films and porous polypropylene films.

Polyolefin separators, especially of polyethylene or polypropylene, may have a porosity in the range from 35 to 45%. Suitable pore diameters are, for example, in the range from 30 to 500 nm.

In another embodiment of the present invention, the separators selected may be separators composed of PET nonwovens filled with inorganic particles. Such separators may have a porosity in the range from 40 to 55%. Suitable pore diameters are, for example, in the range from 80 to 750 nm.

Additionally suitable is glass fiber-reinforced paper or inorganic nonwovens, such as glass fiber nonwovens or ceramic nonwovens.

The procedure for production of the inventive rechargeable electrochemical cells may be, for example, to combine cathode (A), anode (B) and optionally one or more separators with one another and to introduce them into a housing together with any further components. The electrodes, i.e. cathode or anode, may, for example, have thicknesses in the range from 20 to 500 μm, preferably 40 to 200 μm. They may, for example, be in the form of rods, in the form of round, elliptical or square columns, or in cuboidal form, or in the form of flat electrodes.

In a further embodiment of the present invention, above-described inventive rechargeable electrical cells comprise, as well as the electrodes, a liquid electrolyte comprising a lithium-containing conductive salt.

In one embodiment of the present invention, inventive rechargeable electrical cells comprise, as well as the cathode (A) and the anode (B), especially an anode (B) comprising metallic lithium, at least one nonaqueous solvent which may be liquid or solid at room temperature, and is preferably liquid at room temperature, and which is preferably selected from polymers, cyclic and noncyclic ethers, cyclic and noncyclic acetals, cyclic and noncyclic organic carbonates and ionic liquids.

Examples of suitable polymers are especially polyalkylene glycols, preferably poly-C₁-C₄-alkylene glycols and especially polyethylene glycols. These polyethylene glycols may comprise up to 20 mol % of one or more C₁-C₄-alkylene glycols in copolymerized form. The polyalkylene glycols are preferably polyalkylene glycols double-capped by methyl or ethyl.

The molecular weight M_{w} of suitable polyalkylene glycols and especially of suitable polyethylene glycols may be at least 400 g/mol.

The molecular weight M_{w} of suitable polyalkylene glycols and especially of suitable polyethylene glycols may be up to 5 000 000 g/mol, preferably up to 2 000 000 g/mol.

Examples of suitable noncyclic ethers are, for example, diisopropyl ether, di-n-butyl ether, 1,2-dimethoxyethane, 1,2-diethoxyethane, preference being given to 1,2-dimethoxyethane.

Examples of suitable cyclic ethers are tetrahydrofuran and 1,4-dioxane.

Examples of suitable noncyclic acetals are, for example, dimethoxymethane, diethoxymethane, 1,1-dimethoxyethane and 1,1-diethoxyethane.

Examples of suitable cyclic acetals are 1,3-dioxane and especially 1,3-dioxolane.

Examples of suitable noncyclic organic carbonates are dimethyl carbonate, ethyl methyl carbonate and diethyl carbonate.

Examples of suitable cyclic organic carbonates are compounds of the general formulae (I) and (II)

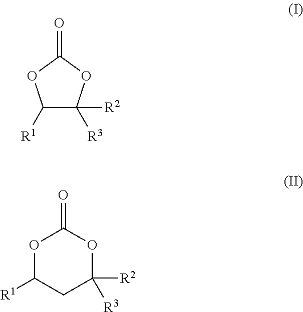

in which R¹, R² and R³ may be the same or different and are selected from hydrogen and C₁-C₄-alkyl, for example methyl, ethyl, n-propyl, isopropyl, n-butyl, isobutyl, sec-butyl and tert-butyl, where R² and R³ are preferably not both tert-butyl.

In particularly preferred embodiments, R¹ is methyl and R² and R³ are each hydrogen, or R¹, R² and R³ are each hydrogen.

Another preferred cyclic organic carbonate is vinylene carbonate, formula (III).

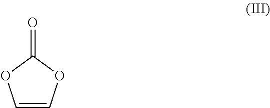

Further preferred solvents are also the fluorinated derivates of the aforementioned solvents, especially fluorinated derivatives of cyclic or noncyclic ethers, cyclic or noncyclic acetals or cyclic or noncyclic organic carbonates, in each of which one or more hydrogen atoms have been replaced by fluorine atoms.

The solvent(s) is (are) preferably used in what is known as the anhydrous state, i.e. with a water content in the range from 1 ppm to 0.1% by weight, determinable, for example, by Karl Fischer titration.

In one embodiment of the present invention, inventive rechargeable electrochemical cells comprise one or more conductive salts, preference being given to lithium salts. Examples of suitable lithium salts are LiPF₆, LiBF₄, LiClO₄, LiAsF₆, LiCF₃SO₃, LiC(CₙF₂ₙ₊₁SO₂)₃, lithium imides such as LiN(CₙF₂ₙ₊₁SO₂)₂, where n is an integer in the range from 1 to 20, LiN(SO₂F)₂, Li₂SiF₆, LiSbF₆, LiAlCl₄, and salts of the general formula (CₙF₂ₙ₊₁SO₂)ₘXLi, where m is defined as follows:

m=1 when X is selected from oxygen and sulfur,

m=2 when X is selected from nitrogen and phosphorus, and

m=3 when X is selected from carbon and silicon.

Preferred conductive salts are selected from LiC(CF₃SO₂)₃, LiN(CF₃SO₂)₂, LiPF₆, LiBF₄, LiClO₄, particular preference being given to LiPF₆ and LiN(CF₃SO₂)₂.

Examples of suitable solvents are especially propylene carbonate, ethylene carbonate, ethyl methyl carbonate, diethyl carbonate and mixtures of at least two of the aforementioned solvents, especially mixtures of ethylene carbonate with ethyl methyl carbonate or diethyl carbonate.

In one embodiment of the present invention, inventive rechargeable electrochemical cells may comprise a further electrode, for example as a reference electrode. Suitable further electrodes are, for example, lithium wires.

Inventive rechargeable electrochemical cells give a high voltage and are notable for a high energy density and good stability. More particularly, inventive rechargeable electrochemical cells are notable for an improved cycling stability.

The inventive rechargeable electrochemical cells can be assembled to metal-air batteries, especially to lithium-air batteries.

Accordingly, the present invention also further provides for the use of inventive rechargeable electrochemical cells as described above in metal-air batteries, especially lithium-air batteries.

The present invention further provides metal-air batteries, especially lithium-air batteries, comprising at least one inventive rechargeable electrochemical cell as described above. Inventive rechargeable electrochemical cells can be combined with one another in inventive metal-air batteries, especially in lithium-air batteries, for example in series connection or in parallel connection. Series connection is preferred.

Inventive rechargeable electrical cells are notable for particularly high capacities, high performances even after repeated charging and greatly retarded cell death. Inventive rechargeable electrical cells are very suitable for use in motor vehicles, bicycles operated by electric motor, for example pedelecs, aircraft, ships or stationary energy stores. Such uses form a further part of the subject matter of the present invention.

The present invention further provides for the use of inventive rechargeable electrochemical cells as described above in motor vehicles, bicycles operated by electric motor, aircraft, ships or stationary energy stores.

The use of inventive metal-air batteries, especially lithium-air batteries, in devices gives the advantage of prolonged run time before recharging and a smaller loss of capacity in the course of prolonged run time. If the intention were to achieve an equal run time with electrochemical cells with lower energy density, a higher weight for electrochemical cells would have to be accepted.

The present invention therefore also further provides for the use of inventive metal-air batteries, especially lithium-air batteries, in devices, especially in mobile devices. Examples of mobile devices are vehicles, for example motor vehicles, bicycles, aircraft, or water vehicles such as boats or ships. Other examples of mobile devices are those which are portable, for example computers, especially laptops, telephones or electrical power tools, for example from the construction sector, especially drills, battery-driven screwdrivers or battery-driven tackers.

The invention is illustrated by the examples which follow but do not restrict the invention. Figures in percent are each based on % by weight, unless explicitly stated otherwise.

I. Production of an inventive rechargeable electrochemical cell

I.I Production of an ink of a cathode active material
To produce an ink, 180 mg of graphitized carbon black (graphitized carbon black of the Vulcan XC72 type from Tanaka, Japan; N2 BET surface area: 92.5 m²/g) and 4.1 g of isopropanol were mixed. The mixture was then predispersed on a sonotrode. Dispersion was effected using a Branson 250 digital probe sonifier for 20 min. Subsequently, 0.85 g of a lithium-Nafion suspension (LITHion® suspension (10.6% Li-exchanged Nafion® in isopropanol)) were added to the dispersed mixture while stirring and the mixture was stirred for a further 30 seconds.

I.II Production of a cathode
The ink produced was applied by means of the Mayer rod method to a Celgard® C480 separator from Celgard (three-ply PP/PE/PP membrane; thickness approx. 21.5 μm) and dried at room temperature. Cathodes were punched out of the coated separator as circular disks with a diameter of 15 mm and then dried in a Büchi glass oven under reduced pressure at 95° C. for 6 h. The resulting carbon loading was 0.41 mg of carbon per cm² of cathode.

I.III Assembly and operation of an inventive rechargeable electrochemical cell
The electrolyte used was 1M LiPF₆ (Sigma-Aldrich, 99.99%) in a 1:2 mixture of propylene carbonate (PC, Aldrich, 99.7%) and 1,2-dimethoxyethane (DME, Aldrich, 99.5%). The water content of the electrolyte was below 4 ppm (by Karl Fischer titration). Lithium-oxygen cells were constructed in an Ar-containing glovebox. Cells were built and used as shown and described in Electrochemical and Solid-State Letters, 13 (6) A70 (2010). Lithium foil was used as the anode, and 40 μl of electrolyte were applied to the lithium foil. Subsequently, 2 plies of Celgard® C480 separator were placed on and a further 40 μl of electrolyte was added to the separators. Subsequently, the cathode (coated separator) was placed on and a further 40 μl of electrolyte were added. A stainless steel mesh (SAE grade 316Ti) was also used as an output conductor on the cathode side. The cell was closed (6 Nm per screw) and purged with pure oxygen at 80 ml/min for 35 seconds. The cell(s) was/were discharged galvanostatically and charged using a VMP3, Bio-Logic, France.
The current was 0.05 mA/cm²_{electrode} (120 mA/g_{carbon}) at a cell potential of not less than 2.0 V (during discharge) and not more than 4.5 V in the course of charging.

1. A rechargeable electrochemical cell comprising
A) at least one cathode comprising
(A1) at least one cathode active material comprising
(a) at least one graphitized carbon black and
(aa) at least one binder, and
optionally at least one solid medium through which gas can diffuse or which optionally serves as a carrier for the cathode active material,
and
B) at least one anode comprising metallic magnesium, metallic aluminum, metallic zinc, metallic sodium or metallic lithium.

2. The rechargeable electrochemical cell according to claim 1, wherein cathode (A) is a gas diffusion electrode.

3. The rechargeable electrochemical cell according to claim 1 or 2, wherein the graphitized carbon black (a) has a BET surface area in the range from 1 to 150 m²/g.

4. The rechargeable electrochemical cell according to any of claims 1 to 3, wherein the graphitized carbon black (a) has been obtained by thermal treatment of a carbon black which has been produced by a process selected from the furnace process, gas black process, lamp black process, acetylene black process and thermal black process, at a temperature of more than 2000° C.

5. The rechargeable electrochemical cell according to any of claims 1 to 4, wherein the graphitized carbon black (a) is in the form of particles having an average particle size in the range from 0.5 μm to 1 μm.

6. The rechargeable electrochemical cell according to any of claims 1 to 5, wherein the cathode active material comprises between 0 and 0.05% by weight, based on the total mass of the cathode active material, of a transition metal or transition metal compound in molecular form or in the form of particles having an average particle size in the range from 1 nm to 100 μm.

7. The rechargeable electrochemical cell according to any of claims 1 to 6, wherein molecular oxygen O₂ is reduced at the cathode (A) in the course of the discharge operation of the electrochemical cell.

8. The rechargeable electrochemical cell according to any of claims 1 to 7, wherein the anode (B) comprises metallic lithium.

9. The rechargeable electrochemical cell according to claim 7 or 8, wherein the electrochemical cell is a lithium-oxygen cell.

10. The rechargeable electrochemical cell according to any of claims 1 to 9, which comprises a liquid electrolyte comprising a lithium-containing conductive salt.

11. The rechargeable electrochemical cell according to any of claims 1 to 10, which comprises at least one nonaqueous solvent selected from polymers, cyclic or noncyclic ethers, noncyclic or cyclic acetals and cyclic or noncyclic organic carbonates.

12. The use of a rechargeable electrochemical cell according to any of claims 1 to 11 in metal-air batteries.

13. A metal-air battery comprising at least one rechargeable electrochemical cell according to any of claims 1 to 11.

14. The use of a rechargeable electrochemical cell according to any of claims 1 to 11 in motor vehicles, bicycles operated by electric motor, aircraft, ships or stationary energy stores.
